(19) United States
(12) Patent Application Publication
(10) Pub. No.: US 2010/0138594 A1
(43) Pub. Date: Jun. 3, 2010

(54) FLASH MEMORY DATA READ/WRITE PROCESSING METHOD

(75) Inventor: He Huang, Guangdong (CN)

Correspondence Address: SEED INTELLECTUAL PROPERTY LAW GROUP PLLC, 701 FIFTH AVE, SUITE 5400, SEATTLE, WA, 98104, US

(73) Assignee: MEMORIGHT MEMORITECH (SHENZHEN) CO., LTD., Guangdong (CN)

(21) Appl. No.: 12/627,841

(22) Filed: Nov. 30, 2009

Related U.S. Application Data
(63) Continuation-in-part of application No. PCT/CN2008/071142, filed on May 30, 2008.

(30) Foreign Application Priority Data
May 30, 2007 (CN) 200710074652.X

(51) Int. Cl. G06F 12/00; G06F 12/02

(52) U.S. Cl. 711/103; 711/E12.001; 711/E12.008

(57) ABSTRACT

A flash memory data read/write processing method is provided. The method includes the following steps. An encoding process is performed on the data to be written so that a number of a specific value in the encoded data is reduced compared with that in the original data, and the encoded data is written into a flash memory chip. The encoded data in the flash memory chip is read out, then a decoding process corresponding to the encoding process in Step 1 is performed on the read data, and finally, the decoded data is output. This method may reduce the consumption of a flash memory chip due to writing and erasing operations, thereby prolonging the operating life span of the flash memory chip. This method may also increase the efficiency of writing and erasing operations, reduce the operating time, as well as reduce the power consumption of flash memory operations.

### BACKGROUND

1. Technical Field

The present disclosure relates to a flash memory data read/write processing method, and more particularly to a method of optimizing flash memory operation by performing an encoding/decoding process on data.

2. Description of the Related Art

A flash memory is a commonly used storage device. The flash memory is widely used in the fields of personal computers, various digital electronic devices, and other various digital storage devices more and more because it may perform data reading/writing and erasing many times, and also has the characteristics of high density, large capacity, low time consumption in a read/write operation as well as non-volatility and low power consumption. In recent years, increasing improvements in technology, gradually reduced cell cost, and increasing improvements in back-end application technology have all greatly stimulated the development of the flash memory market and made the flash memory gradually have equal market share with a hard disk in the storage field. However, the flash memory has had some unavoidable defects since it came into being due to some problems in its own manufacturing process. These defects have limited a further application of the flash memory.

Firstly, a general flash memory chip has an operating life span, which is determined by a flash cell's own storage principle. The flash cell usually operates as follows. First, a floating gate of the memory cell is discharged (i.e., so-called ‘the cell being erased’) to reach a general state. Then, during a process for writing data, the floating gate is charged (i.e., so-called ‘the cell being programmed’) to reach a state needed for storing data. As the number of times the memory cell has been erased and programmed gradually increases, some tunneling electrons will gradually accumulate in the floating gate under a tunneling effect, thereby requiring a larger forward voltage for programming the memory cell again. At the same time, during an erasing operation, an insulator medium is aging under the repeated tunneling effect and finally fails to function as a barrier (i.e., so-called ‘barrier being punctured’). Both the cases will result in the memory cell's inability to operate normally (i.e., so-called ‘the cell's operating period being over’). The most commonly used NAND-type flash memory is used as an example for illustration below. The number of times the NAND-type flash memory can be erased or re-programmed is generally around 100,000.

Secondly, a write operation and an erasing operation of the flash memory chip are special in that the write operation is performed on a page-wise basis and the erasing operation is performed on a block-wise basis. The process time for the write operation and the erasing operation of the flash memory is generally long. The process time for writing data into each page from an interior buffer of the flash memory chip is 200 μs-700 μs, and the time for the erasing operation for a block is 2 ms. At the same time, the operating time is closely related to the technology of the flash memory chip. Due to the erasing operation of a block of flash memory, all memory cells within the block are typically configured to be a state of “1”. During a write process, if the data to be written is 1, a flash memory cell bit corresponding to the data does not need to be re-programmed. If the data to be written is 0, re-programming is employed, i.e., the floating gate is charged. At the same time, before writing data to this page for the next time, an erasing operation is performed once again first, and those memory cells written as 0 will be discharged again. Therefore, during one operation, the larger the number of 0s in a page is, the more the memory cells are consumed in the page.

Thirdly, according to the manufacturing process of the flash memory cell, the time for a write operation of the flash memory is related to the value of data to be written. Specifically, the larger the number of 0s written to a page during each operation is, the longer the time for the operation is. The same is true an erasing operation.

Fourthly, the power consumption of the flash memory chip is related to the content to be written. When a write operation is performed, if data to be written is 1, the floating gate does not need to be charged since the data bit after the erasing operation is 1. On the contrary, if the data to be written is 0, the floating gate must be charged. Therefore, the smaller the number of 0s written in a page is, the less the memory cells needed to be charged are and the lower the power consumption is.

The existing method for addressing the problem of limited operating life span of the flash memory mainly lies in distributing write and erasing operations to each block as equally as possible so that each block is uniformly consumed during the use of the flash memory chip. Currently, this method is widely used by flash memory manufacturers. However, this method only distributes the operating consumption of the flash memory equally in each block of the flash memory chip without reducing the consumption of the flash memory chip.

### BRIEF SUMMARY DISCLOSURE

The present disclosure is directed to providing a flash memory data read/write processing method, which is applicable for reducing the number of times of operation causing consumption on a flash memory cell, increasing the life span and storage efficiency of the flash memory, and reducing the power consumption during the operation of the flash memory.

One embodiment of the present disclosure provides a flash memory data read/write processing method, which may include the following steps.

Step 1: during writing data to the flash memory chip, an encoding process is performed on the data to be written, so that a number of a specific value in the encoded data is reduced compared with that in the data before being encoded, and then the encoded data are written into a flash memory chip.

Step 2: during reading the data recorded in the flash memory chip, first the encoded data in the flash memory chip is read out, and then a decoding process corresponding to the encoding process in Step 1 is performed on the read data, and the decoded data is output.

When the data is binary data, the specific value may be 0 or 1.

Step 1 may include performing the encoding process on the data to be written at either a system host side, a flash memory controller side, or the flash memory chip side.

Step 2 may include performing the decoding process on the read data at either a system host side, a flash memory controller side, or the flash memory chip side.

The method may further include storing the encoded/decoded information within the flash memory chip.

The number of the specific value in each set of binary data after the encoding process in Step 1 may be no more than the number of the specific value in the corresponding set of binary data before the encoding process, and the decoding process in Step 2 may be corresponding to the encoding process in Step 1.

The method may further include creating a mapping relationship between the data and the encoded data so that the number of the specific value in the encoded data is smaller than that in the original data. The encoding process of Step 1 and the decoding process in Step 2 may be carried out by querying the mapping relationship.

The encoding process of Step 1 may include performing an inverse operation on the data in which the number of the specific value is larger than that of any one of other values, and the decoding process in Step 2 may include performing an inverse on the inversed data in the encoding process to obtain the original data.

In a set period, a total number of the specific value in all sets of binary data after the encoding process in Step 1 may be smaller than that in all sets of binary data before the encoding process, and the decoding process in Step 2 may be corresponding to the encoding process in Step 1.

For an NAND-type flash memory, Step 1 may include performing the encoding process on the binary data to be written so that the number of 0s in the encoded binary data is smaller than that in the data before the encoding process, and writing the encoded binary data into the flash memory chip.

The flash memory data read/write processing method according to one embodiment of the present disclosure mainly reduces the number of specific value in the data by way of encoding/decoding operation, thereby reducing the consumption of the flash memory chip by the write and erasing operations, and prolonging the operating life span of the flash memory chip. Secondly, the process reduces the number of written data with specific value in the flash memory chip, increases the efficiency of the write and erasing operations, and reduces the operating time. Thirdly, this encoding/decoding operation method reduces the power consumption of flash memory operations.

### BRIEF DESCRIPTION OF THE SEVERAL VIEWS OF THE DRAWINGS

The present disclosure will become more fully understood from the detailed description given herein below for illustration only, and thus are not limitative of the present disclosure, and wherein:

FIG. 1 is a schematic view illustrating the principles of an encoding/decoding process on a flash memory controller side according to an embodiment of the present disclosure;

FIG. 2 is a schematic view illustrating a write operation in the embodiment of the present disclosure in which the encoding/decoding process is performed on the flash memory controller side;

FIG. 3 is a schematic view illustrating a read operation in the embodiment of the present disclosure in which the encoding/decoding process is performed on the flash memory controller side;

FIG. 4 is a schematic view illustrating a data operation in a page of a flash memory chip in which a method according to an embodiment of the present disclosure is applied;

FIG. 5 is a schematic view illustrating a data operation in a page of a flash memory chip in which a method according to an embodiment of the present disclosure is not applied;

FIG. 6 is a schematic view showing original 4-bit data in an embodiment of the present disclosure in which a mapping encoding/decoding operation is applied;

FIG. 7 is a schematic view showing data increased by 2 bits in width in the embodiment of the present disclosure in which the mapping encoding/decoding operation is applied;

FIG. 8 is a schematic view showing a mapping relationship between the 4-bit original data and the data with increased 2 bits in the embodiment of the present disclosure in which the mapping encoding/decoding operation is applied;

FIG. 9 is a schematic view showing the uncompressed original data in an embodiment of the present disclosure in which a compression encoding/decoding operation is applied;

FIG. 10 is a schematic view showing a relationship between the original data and the data being compression encoded in the embodiment of the present disclosure in which the compression encoding/decoding operation is applied; and

FIG. 11 is a schematic view showing the data being compression-encoded in the embodiment of the present disclosure in which the compression encoding/decoding operation is applied.

### DETAILED DESCRIPTION DISCLOSURE

The present disclosure will be illustrated in detail below by taking an NAND-type flash memory as an example in combination with the accompanying drawings. Also, the present disclosure will be illustrated using an example in which the flash memory stores binary data and in which an written state is 0 and an erased state is 1, although those skilled in the art will understand that the logic values of the written and erased states could be reversed.

According to the operating characteristics of a memory cell within a flash memory block, the main factor affecting the life span of the memory cell lies in the consumption of the memory cell caused by an operation from 1 to 0 during a write operation and an operation from 0 to 1 during an erasing operation. Therefore, after an erasing operation of the block, the smaller the number of 0s to be written to a page is, the smaller the number of memory cells to be consumed during a later erasing operation is and the larger the number of times the block can be used is. According to a statistical method, the life span of an entire flash memory chip will be prolonged as well. At the same time, operating time may be reduced and an efficiency of the write and erasing operations may be increased by a method of controlling the value of data to be written. Meanwhile, the power consumption of the operation of the flash memory may be reduced by controlling the value of the data to be written. The present disclosure achieves the purposes of prolonging the life span of the flash memory, optimizing the operation of flash memory, and reducing the power consumption of the flash memory by a method of optimizing the data to be written through encoding/decoding.

Various methods of encoding may be employed in the present disclosure. The original data may be encoded by using an algorithm so that the number of 0s in the data having been encoded is smaller than that in the original data. Besides, the amount of data to be written to the memory cell, and more importantly the number of 0s in the data, may be reduced by a data compression method. Various algorithms may be employed in an encoding/decoding operation of the present disclosure, of which the main purposes lie in that the data to be written is encoded during a write operation so that the encoded data contain as few 0s as possible to reduce the consumption of the memory cell by the write and erasing operations, and at the same time the original data may be restored by a corresponding decoding operation during a read operation.

The encoding/decoding operation in the read/write operation of the flash memory provided by the present disclosure can be realized widely and may be implemented in the following manners. Firstly, the encoding/decoding operation may be implemented by software. Before a host sends data to a flash memory device, the encoding operation is directly performed on the data, and then the encoded data is sent to an interface of the flash memory device. When the host reads the flash memory device, the decoding operation is directly performed on the data read from the interface of the flash memory device, and then the decoded data can be transmitted to other storage devices. Secondly, the encoding/decoding operation may be implemented by hardware. An encoding/decoding module may be added in a controller module in the flash memory device. During the write operation, after the encoding module receives data sent from the interface of the device, it performs the encoding operation on the data and then sends the encoded data to a flash memory chip for storage. During the read operation, the controller module reads out the encoded data in the flash memory chip, performs the decoding operation, and finally transmits the decoded data to the host through the interface. Thirdly, the encoding/decoding operation may be implemented by an encoding/decoding module added within the flash memory chip. When the flash memory chip receives data sent from an external controller module, it directly performs the encoding operation on the data, and then writes the encoded data into a memory cell with a corresponding address. When the controller module performs the read operation on the flash memory chip, the encoding/decoding module within the flash memory chip first performs the decoding operation on the encoded data read from the memory cell with the corresponding address, and then sends the result to the controller module. The encoding module and decoding module can be respectively and separately set at different devices, including a system host, a flash memory controller, or the flash memory chip.

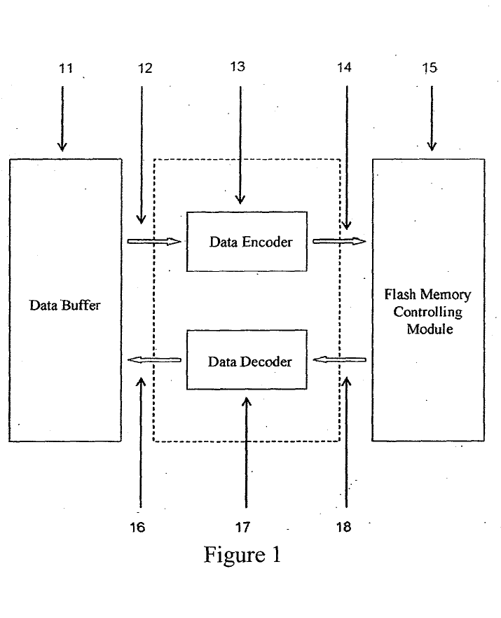

FIG. 1 is a schematic view illustrating the principles of the encoding/decoding operation on the flash memory controller according to an embodiment of the present disclosure. In the figure, numeral 11 indicates a data buffer in the flash memory device, for buffering data during operation. Numeral 12 indicates writing of data from the data buffer to a data encoder during a write operation of the device. Numeral 13 indicates the encoder in the encoding/decoding module, which mainly functions to perform an encoding operation on the data written from the buffer and write the corresponding encoded information into a redundant area or an information area in a flash memory chip. Numeral 14 indicates writing of the data after being processed by the encoder in the encoding/decoding module into a flash memory controlling module. Numeral 15 indicates the flash memory controlling module for controlling the operation of the flash memory chip and transmitting the encoded data to the flash memory chip. Numeral 18 indicates the flash memory controller reading data stored within the flash memory chip and transmitting the same to a decoder during a read operation. Numeral 17 indicates the decoder in the encoding/decoding module, which mainly functions to perform a corresponding decoding operation on data in a data area according to the encoded information recorded in the flash memory chip, and then transmit (as indicated by 16 in the figure) the decoded result to the data buffer.

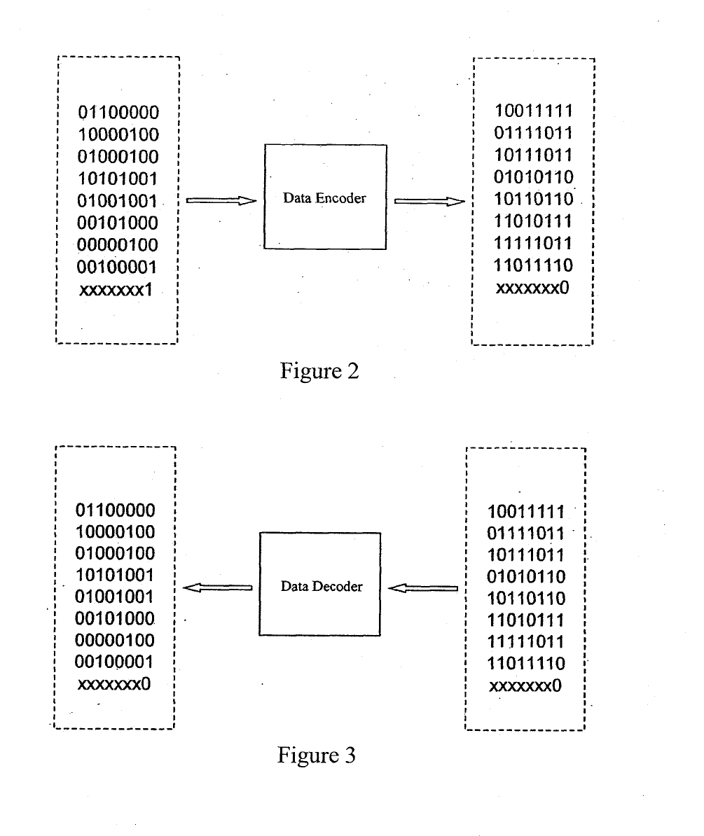

FIG. 2 shows an encoding operation during a write operation of a certain page according to an embodiment of the present disclosure. As shown in the figure, a data operating area and a redundant area of the page are set to be 8 bytes and 1 byte in size, respectively, i.e., each write operation for the flash memory chip is performed in a unit of 9 bytes. Assume an arbitrarily selected page in which data are shown in a block in the left of the figure as “01100000 10000100 01000100 10101001 01001001 00101000 00000100 00100001”, where data in the redundant area is “xxxxxxx1”. The 8^{th} bit of the redundant area is a designated encoded information and the first 7 bits record other data information. After being computed by the encoder, the number of 0s is 46 and the number of 1s is 18. The encoder determines to perform an encoding operation on the data. The data shown in a block in the right of the figure as “11001111 01111011 10111011 01010110 10110110 11010111 11111011 11011110” are those obtained through an algorithm according to an example of the present disclosure, and the encoded information is written into the redundant area as “xxxxxxx0” (here it is defined that the encoded information bit of 0 represents that an inverse operation has been performed; and the encoded information bit of 1 represents that the inverse operation has not been performed). After being computed by the encoder on the data area, the number of 0s is 18 and the number of 1s is 46. The encoded data is written into the flash memory chip, and a corresponding mark is written in the designated bit within the redundant area to record that the inverse operation has been performed on the data of the page.

FIG. 3 shows a decoding operation during a read operation of data recorded in a certain page according to an embodiment of the present disclosure. As shown in the figure, a decoder performs the decoding operation on the encoded result and reads out the data originally written to the device according to the mark bit information in the redundant area written during the writing operation as shown in FIG. 2.

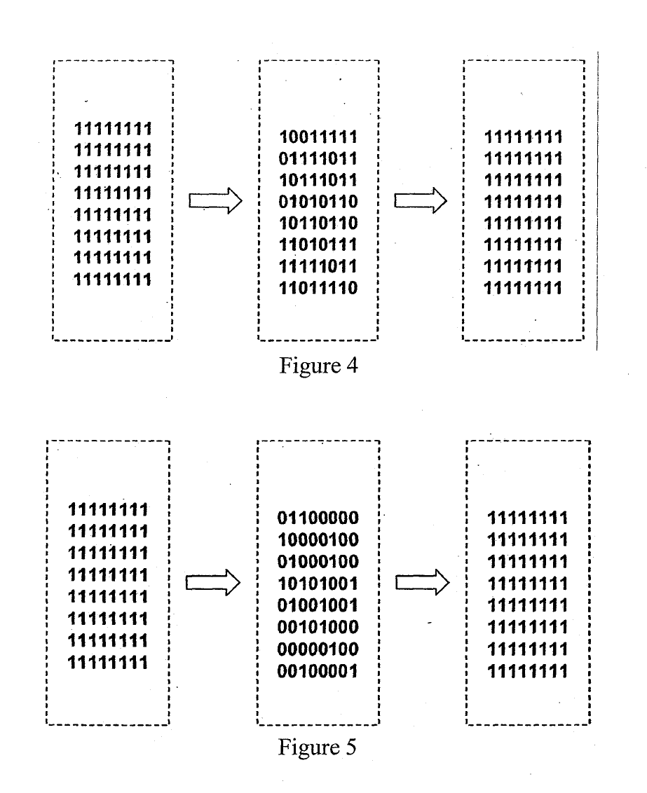

FIG. 4 shows the changes of memory cell bits in the data area of a certain page within the flash memory chip after a write operation and a final erasing operation of this page in an embodiment of the present disclosure. First, an erasing operation is performed on the page of the flash memory chip with the address to be operated before writing data. After the erasing operation, as shown in the left block in the figure, all the memory cells are changed to be 1. And then, the data is written. During the write operation, if the value of data to be written into a memory cell is 1, the memory cell does not need to be charged. If the value of data to be written into a memory is 0, a charging operation on the memory cell is performed and the memory cell is correspondingly written as 0, as shown in the middle block in the figure. Finally, the erasing operation is performed on the written data, i.e. all the bits are discharged. If a bit is 1, it is not consumed during the current write and erasing operations. If a bit is 0, it is consumed once during the current write and erasing operations.

Statistics are performed on this embodiment. 46 memory cells will be consumed if data to be written are not processed by the encoding/decoding operation of the embodiment of the present disclosure, as shown in FIG. 5. If data to be written are processed according the embodiment of the present disclosure, 18 memory cells will be consumed. Accordingly, the number of memory cells which are consumed is greatly reduced. Similarly, the operating life span can be effectively prolonged for both the entire flash memory chip and the flash memory device. At the same time, according to the characteristics of write and erasing operations of a flash memory, the smaller the number of 0s in the data to be written or erased during each operation is, the shorter the operating time is, and the higher the efficiency is. At the same time, the smaller the number of 0s is, the less the energy consumption required by the operation is.

The present disclosure is illustratively described in the above example with an inverse operation, which is the most simple and handy algorithm as an example. In addition, the present disclosure may be implemented by using various algorithms and methods, and may be implemented not only by software but also by hardware. The ultimate purpose of the present disclosure is to reduce consumption of the flash memory cell due to operations as much as possible, and to reduce the consumption of the flash memory chip due to the data written into the flash memory chip as much as possible, thereby achieving the purpose of optimizing the flash memory, such as, prolonging the operating life span of the flash memory chip and the flash memory device, shortening the operating time, increasing the operating rate of the flash memory, as well as reducing the power consumption of flash memory operations.

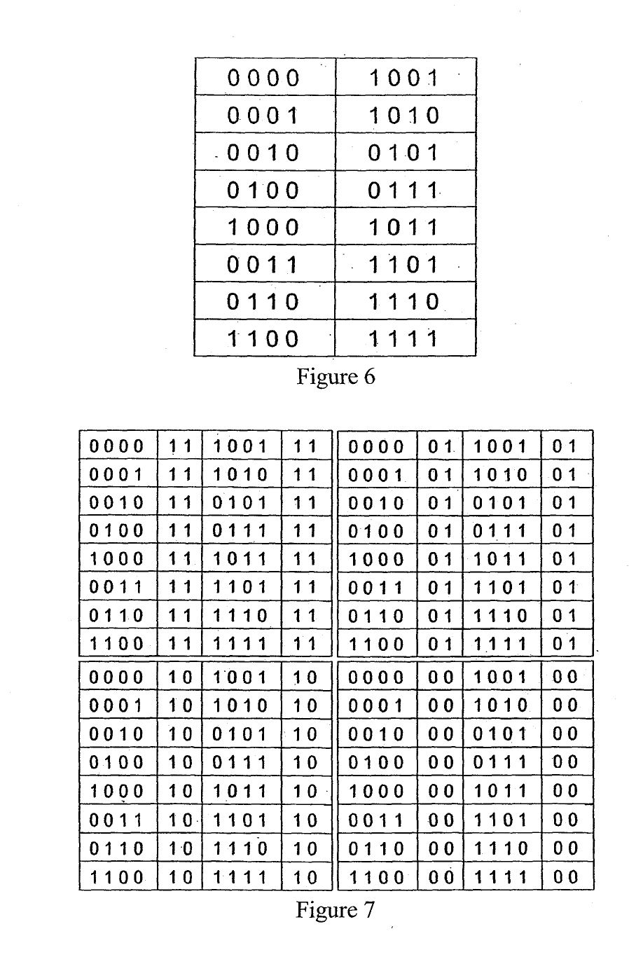

An encoding/decoding process by using a mapping operation is introduced below. As shown in FIG. 6, 4-bit data are used as an example in this embodiment. The figure shows all possible 4-bit data, in which one has zero 0s, four have one 0, six have two 0s, four have three 0s, and one has four 0s.

FIG. 7 shows all the possible cases of 4-bit data after a 2-bit redundant area is added, in which one contains zero 0, six contain one 0, fifteen contain two 0s, twenty contain three 0s, fifteen contain four 0s, six contain five 0s, and one contains six 0s.

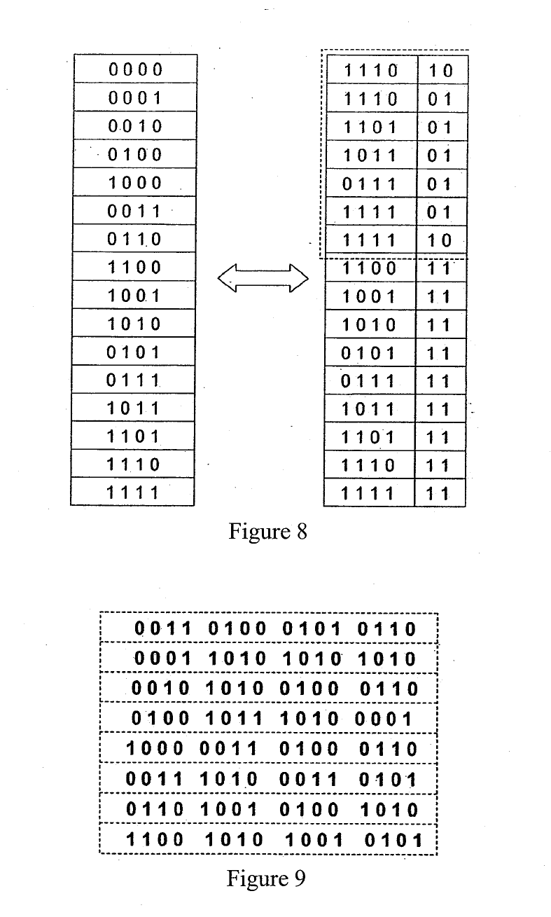

As shown in FIG. 8, a mapping relationship is created between the 4-bit data and the 6-bit data containing the 2-bit redundant area. After performing an encoding operation on data during writing data according to this mapping relationship, the number of 0s in the data may be greatly reduced. In the mapped 6-bit data in the figure, one has zero 0, six have one 0, and nine have two 0s.

Statistics are performed on the above results. Since data is randomly generated, each data of those shown in FIG. 8 has the same probability of being recorded and written into a flash memory chip. Assume each data is written n times, the number of times of writing 0 is 4n+12n+12n+4n=32n, and the actual number of times of writing 0 after the encoding operation is 6n+18n=24n. According to the statistics, a total of 8n times of writing 0 are reduced, and the 4-bit writing operation is performed for 16n times. Therefore, a consumption saving of 12.5% may be achieved for each memory cell after the writing operation of this embodiment.

During reading data, the data being encoded are read from the flash memory cell and a decoding operation is performed according to the mapping relationship, where the decoding operation is an inverse operation of the encoding operation to obtain the corresponding original data.

According to the above mapping principle, each flash memory page includes a data area of 2048 B and a redundant area of 64 B. An encoding operation may be created. The host data is encoded and written into the flash memory cells. Due to the existence of the redundant area, the number of bits of the encoded data is larger than the number of bits of the original host data. Such encoding operation creates a new mapping relationship between the host data and the data with increased number of bits, so that the number of 0s in the data after the encoding operation is smaller than that in the original host data, thereby achieving purposes of reducing the consumption of the flash memory chip, and prolonging the life span of the flash memory device.

A compression-encoding process being employed by an embodiment of the present disclosure is illustrated in detail below. The present disclosure employs an encoding operation as an example with a simple implementation. Statistics are performed on occurrence frequencies of hexadecimal data in a data segment. The number of bits of encoded data is determined according to the occurrence frequencies. For a data with the highest occurrence frequency, the encoded data is 0, followed by 10, 110, 1110 . . . in turn according to the frequencies. One bit of “1” is added as the highest bit each time. In case of more than one data with the same frequency, each data being encoded is determined by the hexadecimal value corresponding to the data. The smaller the value is, the smaller the number of bits of the encoded data is, and vice versa.

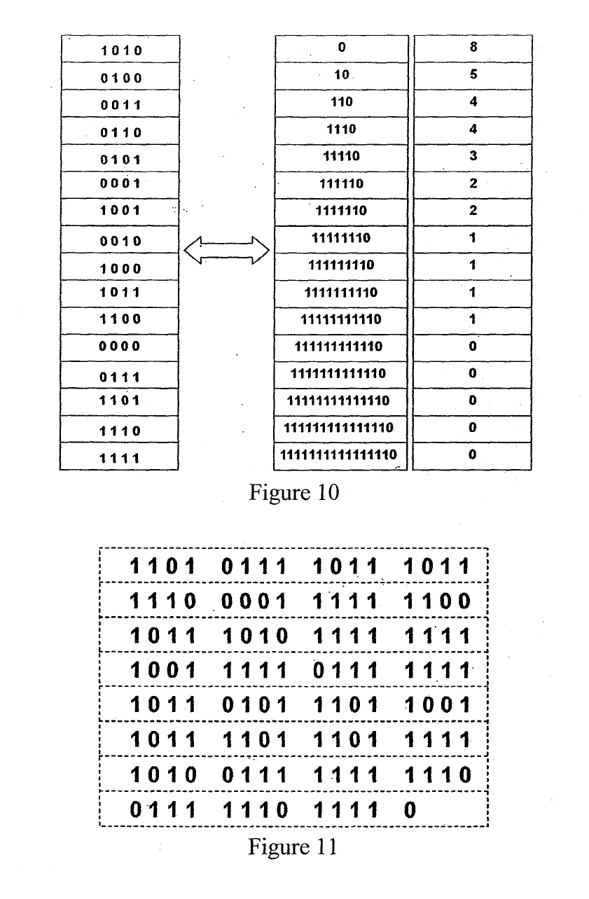

FIG. 9 shows the original 128-bit data without being processed by a compression operation. The compression operation is performed in an operational unit of 4 bits. According to statistics, the number of times for each 4-bit data occurring in the original data is shown in FIG. 10. A compression encoding operation is designed according to data writing frequencies of the statistical result, in which a relationship between the original data and the data being compression encoded is shown in FIG. 10. According to the statistics, the number of 0s in the original data without being processed by the compression operation is 72 and the number of 1s is 56.

A result shown in FIG. 11 may be obtained by performing the compression encoding operation on the original 128-bit data. The data after being processed by the compression operation has 125 bits, wherein the number of 0s is 32 and the number of 1s is 93. Compared with the data before being compressed, it is found that the number of 0s is reduced by 40 and the total number of data bits is reduced by 3. Therefore, the number of 0s in the data may be effectively reduced, and meanwhile the number of written data bits may be reduced by such compression encoding operation.

During a read operation of the data, first, the written encoded data is read from the flash memory cell, and a decoding operation is performed according to the relationship between the compressed data and the original data in the compression operation, where the decoding operation is an inverse operation of the encoding operation, so as to obtain the corresponding original data.

Besides the above compression encoding/decoding algorithm, it has many implementations for a compression encoding/decoding algorithm, and merely one is provided here as an example. The main purpose thereof is to reduce the number of bits of the written data, especially the number of 0s in the data by the compression algorithm, thereby achieving purposes of reducing the consumption of the flash memory, prolonging the life span of the device, as well as optimizing the writing speed, and reducing its power consumption.

Although only a few embodiments are introduced in the present disclosure for illustration, it has many available algorithms, all of which are follow the guiding principle of the present disclosure and is apparent to those skilled in the art. In addition, the memory chip provided in the present disclosure includes not only NAND, NOR etc., other semiconductor memory chips having similar writing consumption all fall in the guiding principle and scope of the present disclosure, and any changes apparent to those skilled in the art are within the scope of the present disclosure. For example, the above examples assume that the written state is a logic 0, and therefore the above examples encode the data to be written in a manner that limits the number of 0s in the encoded data. However, the methods discussed above can be applied to memories in which the written state is a logic 1 by encoding the data to be written in a manner that limits the number of 1s in the encoded data.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A flash memory data read/write processing method, comprising:
producing encoded data by performing an encoding process on input data to be written, the input data including a first number of data of a specific value and the encoded data including a second number of data of the specific value, the second number being reduced compared with the first number;
writing the encoded data into a flash memory chip;
reading out the encoded data from the flash memory chip;
producing decoded data by performing a decoding process, corresponding to the encoding process, on the read data; and
outputting the decoded data.

2. The flash memory data read/write processing method as claimed in claim 1, wherein when the data is binary data and the specific value is 0 or 1.

3. The flash memory data read/write processing method as claimed in claim 2, wherein the input data includes a plurality of input data sets, the encoded data includes a plurality of encoded data sets corresponding respectively to the input data set, and the number of data of the specific value in each encoded data set of data is no more than the number of data of the specific value in the corresponding input data set.

4. The flash memory data read/write processing method as claimed claim 2, wherein the input data includes a plurality of input data sets and the encoded data includes a plurality of encoded data sets corresponding respectively to the input data set, and wherein in a particular period, a total number of data of the specific value in all of the encoded data sets smaller than a total number of data of the specific value in all of the input data sets.

5. The flash memory data read/write processing method as claimed in claim 2, wherein the flash memory chip is a NAND-type flash memory chip, and the specific value is 0.

6. The flash memory data read/write processing method as claimed in claim 1, wherein performing the encoding process comprises performing the encoding process on the input data to be written at any of a system host, a flash memory controller, and the flash memory chip.

7. The flash memory data read/write processing method as claimed in claim 6, wherein the input data includes a plurality of input data sets, the encoded data includes a plurality of encoded data sets corresponding respectively to the input data set, and the number of data of the specific value in each encoded data set of data is no more than the number of data of the specific value in the corresponding input data set.

8. The flash memory data read/write processing method as claimed claim 6, wherein the input data includes a plurality of input data sets and the encoded data includes a plurality of encoded data sets corresponding respectively to the input data set, and wherein in a particular period, a total number of data of the specific value in all of the encoded data sets smaller than a total number of data of the specific value in all of the input data sets.

9. The flash memory data read/write processing method as claimed in claim 1, wherein performing the decoding process comprises performing the decoding process on the read data at any of a system host, a flash memory controller, and the flash memory chip.

10. The flash memory data read/write processing method as claimed in claim 9, wherein the input data includes a plurality of input data sets, the encoded data includes a plurality of encoded data sets corresponding respectively to the input data set, and the number of data of the specific value in each encoded data set of data is no more than the number of data of the specific value in the corresponding input data set.

11. The flash memory data read/write processing method as claimed claim 9, wherein the input data includes a plurality of input data sets and the encoded data includes a plurality of encoded data sets corresponding respectively to the input data set, and wherein in a particular period, a total number of data of the specific value in all of the encoded data sets smaller than a total number of data of the specific value in all of the input data sets.

12. The flash memory data read/write processing method as claimed in claim 1, further comprising storing the decoded data within the flash memory chip.

13. The flash memory data read/write processing method as claimed in claim 1, wherein the input data includes a plurality of input data sets, the encoded data includes a plurality of encoded data sets corresponding respectively to the input data set, and the number of data of the specific value in each encoded data set is no more than the number of data of the specific value in the corresponding input data set.

14. The flash memory data read/write processing method as claimed in claim 13, further comprising creating a mapping relationship between the input data and the encoded data, wherein the encoding process and the decoding process are carried out by querying the mapping relationship.

15. The flash memory data read/write processing method as claimed in claim 13, wherein the encoding process comprises performing an inverse operation on portions of the input data in which the number of data of the specific value is larger than the number of data of any one of other values, and the decoding process comprises performing an inverse operation on the inverted data to obtain the input data.

16. The flash memory data read/write processing method as claimed in claim 1, wherein the input data includes a plurality of input data sets and the encoded data includes a plurality of encoded data sets corresponding respectively to the input data set, and wherein in a particular period, a total number of data of the specific value in all of the encoded data sets smaller than a total number of data of the specific value in all of the input data sets.

17. The flash memory data read/write processing method as claimed in claim 1, wherein the flash memory chip is a NAND-type flash memory chip, and the specific value is 0.
